(19) United States
(12) Patent Application Publication
(10) Pub. No.: US 2026/0286176 A1
(43) Pub. Date: Sep. 24, 2026

(54) HYBRID POLYURETHANE-SILANE WATERBORNE PRIMER, METHODS FOR ITS PREPARATION AND METHODS FOR USING

(71) Applicant: SWIMC LLC, Cleveland, OH (US)

(72) Inventors: Liang LIANG, Twinsburg, OH (US); Peter MAASSEN VAN DEN BRINK, Amsterdam (NL)

(21) Appl. No.: 19/475,461

(22) PCT Filed: Apr. 11, 2024
(86) PCT No.: PCT/US2024/023998

§ 371 Date: Oct. 15, 2025

Related U.S. Application Data
(60) Provisional application No. 63/460,152, filed on Apr. 18, 2023.

(51) Int. Cl. C09D 175/04; C09D 5/00; C09D 7/63; C09D 7/80

(52) U.S. Cl. CPC C09D 175/04; C09D 5/002; C09D 7/63; C09D 7/80

(57) ABSTRACT

Hybrid polyurethane-silane waterborne primer compositions are provided, along with methods for their production and their use.

### CROSS-REFERENCE TO RELATED APPLICATIONS

The present invention is related to, and claims priority to, U.S. Provisional Application Ser. No. 63/460,152, filed Apr. 18, 2023, pending, the entire contents of which are incorporated herein by reference.

### TECHNICAL FIELD

The present invention relates to hybrid polyurethane-silane containing resin waterborne primer compositions, methods for their production and methods for using them, particularly as primers on substrates containing metal surfaces.

### BACKGROUND OF THE INVENTION

There is an increasing demand for the development and use of waterborne coatings due to environmental considerations, especially the negative impacts on environment resulting from solvent-borne coating solutions, and particularly the volatile organic compounds (VOC) associated therewith. Solvent borne primers are frequently used in the refinishing of vehicles, which provide improved performance in areas such as anticorrosion. However, the VOC associated with solvent-borne primers is one of the critical issues prompting interest in a switch to waterborne primers.

Low VOC and zero emission are significant advantages of waterborne coatings, providing a motivation to develop various waterborne coating solutions. Many efforts had been addressed to replace solvent-borne primers with waterborne primers. However, past efforts have resulted in poor performance, particularly in the area of anticorrosion, thus restricting the use of waterborne primers, especially for refinished vehicles and for coating other metal surfaces in particular.

A primer is a paint or coating product that allows finishing paint to adhere to a surface much better than if it were used alone. It is designed to adhere to surfaces and to form a binding layer that is better prepared to receive the paint. Compared to paint, a primer is not typically intended to be used as the outermost durable finish and can instead be engineered to have improved filling and binding properties with the material underneath. Sometimes this can be achieved by chemistry, and others by controlling the primer's physical properties such as its porosity, tackiness, and hygroscopy.

### SUMMARY OF THE INVENTION

Accordingly one object of the present invention is to provide hybrid waterborne primer compositions that have a combination of properties not otherwise attainable with a single polymer based primer.

A further object of the present invention is to provide hybrid waterborne primer compositions that can be applied to substrates, particularly metal substrates, without the need for use of an etch primer.

A further object of the present invention is to provide hybrid waterborne primer compositions that can be applied to substrates, particularly metal substrates, after initial application of an etch primer, with the hybrid waterborne primer composition providing comparable or improved adhesion, anticorrosion, and anti-hydrolysis properties, among other properties when compared to conventional solvent borne primers used with solvent borne etch primers.

Another object of the present invention is to provide methods for the production of the hybrid waterborne primer compositions of the present invention, and methods for their use.

These and other objects of this invention, alone or in combination, have been satisfied by the discovery of a hybrid primer comprising a crosslinked polymer network formed from a polyurethane dispersion, an organosilicon based compound containing one or more isocyanate functional groups, and, optionally, an additional isocyanate containing compound,
methods for their production and for their application in substrate coating, particularly metal substrate coating.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a schematic illustration of the crosslinking of a polyurethane network by reaction of a polyurethane dispersion with an isocyanate containing compound.

FIG. 2 is a schematic illustration of the crosslinking of a polyurethane network by reaction with an exemplary organosilane compound containing one or more isocyanate groups of certain embodiments of the present invention.

FIG. 3 is a schematic illustration of the crosslinking of a polysiloxane by hydrolysis and condensation of an exemplary organosilane compound containing one or more isocyanate groups of certain embodiments of the present invention.

FIG. 4 is a schematic illustration of grafting of an exemplary organosilane compound containing one or more isocyanate groups of certain embodiments of the present invention on a cold rolled steel substrate by reaction of an isocyanate group on the organosilane compound and amine (or hydroxyl) groups on the substrate or on a layer of a hybrid epoxy-polysiloxane waterborne etch primer.

FIG. 5 is a photographic representation of anticorrosion performance after salt spray chamber testing of substrates coated with a conventional 2K polyurethane solvent borne primer (samples (a) and (b)) and a waterborne polyurethane dispersion without the organosilicon compound modification of embodiments of the present invention (samples (c), (d), (e), and (f)). Both the conventional 2K polyurethane solvent borne primer control and embodiments of the present invention are coated on the surface of a 2K solvent borne epoxy etch primer placed first on the substrate.

FIG. 6A is a photographic representation of anticorrosion performance after salt spray chamber testing of substrates coated with a conventional 2K polyurethane solvent borne primer (samples (a) and (b)) compared to a waterborne polyurethane-silicon containing resin hybrid primer of embodiments of the present invention (samples (c), (d), (e), and (f)). The conventional 2K polyurethane solvent borne primer control is coated on the surface of a 2K solvent borne epoxy etch primer placed first on the substrate, and embodiments of the present invention are coated on the surface of a hybrid epoxy-polysiloxane waterborne etch primer placed first on the substrate.

FIG. 6B provides a graphical representation of anticorrosion performance from the photographs of FIG. 6A.

### DETAILED DESCRIPTION OF THE INVENTION

The present invention relates to hybrid polyurethane-silane waterborne primers, methods used to prepare the primers and their use as coatings on substrates, particularly metal substrates. The hybrid polyurethane-silane waterborne primers of the invention can be used alone as a direct-to-substrate (or in certain embodiments, direct-to-metal or “DTM”) primer, or in combination with a surface treatment on the substrate to be coated, such as an etching primer or other chemical surface treatment to render the surface of the substrate better able to receive and bond with the hybrid waterborne primer of the invention.

Within the context of the present invention, the term “hybrid primer” includes, but is not limited to, semi- and fully interpenetrating crosslinked networks of two polymer types, blends of two different polymer types that have been chemically bonded either directly or via a linking agent, chemically bonded crosslinked networks of two polymer types, a crosslinked network of one polymer type chemically modified by a compound that then can form its own crosslinked network after bonding to the original crosslinked network, and the like.

Within the context of the present invention, the term “waterborne” is intended to mean that the polymeric components are in an aqueous medium. In certain embodiments, waterborne coatings provide one or more of the following advantages:
Low toxicity and flammability due to low VOC levels and low HAP emissions
Lower cost than solvent-borne coatings and no additives, thinners, or hardeners are required in most cases
Less coating is required to cover the same surface area as compared to the use of solvent borne coating solutions
Paint guns can be readily cleaned with water or water-based solutions and do not require paint thinner, acetone, or methyl acetate (further environmentally friendly and user safety friendly)
Reduced risk to the environment when discharging and processing waste solution used for cleaning equipment

The term “comprises” and variations thereof do not have a limiting meaning where these terms appear in the description and claims.

The recitation of a numerical range using endpoints includes all numbers subsumed within that range (e.g., 1 to 5 includes 1, 1.5, 2, 2.75, 3, 3.80, 4, 5, etc.).

To the extent that the terms “including”, “includes”, “having”, “has”, “with”, or variants thereof are used in the present application, such terms are intended to be inclusive in a manner similar to the term “comprising.” The singular forms “a”, “an” and “the” include plural referents unless the context clearly dictates otherwise. Additionally, the terms “a,” “an,” “the,” “at least one,” and “one or more” are used interchangeably. Thus, for example, a coating composition that contains “an” additive means that the coating composition can include “one or more” additives. Approximating language, as used herein throughout the specification and claims, may be applied to modify a quantitative representation that could permissibly vary without resulting in a change in the basic function to which it is related. Accordingly, a value modified by a term such as “about” is not to be limited to the precise value specified. In some instances, the approximating language may correspond to the precision of an instrument for measuring the value. Moreover, unless specifically stated otherwise, a use of the terms “first,” “second,” etc., do not denote an order or importance, but rather the terms “first,” “second,” etc., are used to distinguish one element from another.

As used herein, the terms “may” and “may be” indicate a possibility of an occurrence within a set of circumstances; a possession of a specified property, characteristic or function; and/or qualify another verb by expressing one or more of an ability, capability, or possibility associated with the qualified verb. Accordingly, usage of “may” and “may be” indicates that a modified term is apparently appropriate, capable, or suitable for an indicated capacity, function, or usage, while taking into account that in some circumstances the modified term may sometimes not be appropriate, capable, or suitable. For example, in some circumstances an event or capacity can be expected, while in other circumstances the event or capacity cannot occur—this distinction is captured by the terms “may” and “may be.”

In the specification and claims, reference will be made to a number of terms that have the following meanings. The singular forms “a”, “an” and “the” include plural referents unless the context clearly dictates otherwise. Approximating language, as used herein throughout the specification and claims, may be applied to modify a quantitative representation that could permissibly vary without resulting in a change in the basic function to which it is related. Accordingly, a value modified by a term such as “about” is not to be limited to the precise value specified. In some instances, the approximating language may correspond to the precision of an instrument for measuring the value. Moreover, unless specifically stated otherwise, a use of the terms “first,” “second,” etc., do not denote an order or importance, but rather the terms “first,” “second,” etc., are used to distinguish one element from another.

The term “aqueous” composition or dispersion herein means that particles are dispersed in an aqueous medium. An “aqueous medium” herein has a continuous phase of water that makes up at least 50 weight percent of the aqueous medium, wherein the remaining composition of the aqueous medium comprises particles and water-miscible compound(s) such as, for example, alcohols, glycols, glycol ethers, glycol esters, and the like.

The term “dispersion” in the context of the present invention refers to the mixture of a dispersible polymer and a carrier. The term “dispersion” includes, but is not limited to, the term “solution.”

The terms “preferred” and “preferably” refer to embodiments of the invention that may afford certain benefits, under certain circumstances. However, other embodiments may also be preferred, under the same or other circumstances. Furthermore, the recitation of one or more preferred embodiments does not imply that other embodiments are not useful and is not intended to exclude other embodiments from the scope of the invention.

As used herein, the term “structural units,” also known as polymerized units, of the named monomer refers to the remnant of the monomer after polymerization, or the monomer in polymerized form.

All methods described herein can be performed in any suitable order unless otherwise indicated herein or otherwise clearly contradicted by context. The use of any examples, or language describing an example (e.g., “such as”) provided herein, is intended to illuminate the invention and does not pose a limitation on the scope of the invention. Any statement herein as to the nature or benefits of the invention or of the preferred embodiments is not intended to be limiting. This invention includes all modifications and equivalents of the subject matter recited herein as permitted by applicable law. Moreover, any combination of the above-described elements in all possible variations thereof is encompassed by the invention unless otherwise indicated herein or otherwise clearly contradicted by context. The description herein of any reference or patent, even if identified as “prior,” is not intended to constitute a concession that such reference or patent is available as prior art against the present invention. No unclaimed language should be deemed to limit the invention in scope. Any statements or suggestions herein that certain features constitute a component of the claimed invention are not intended to be limiting unless reflected in the appended claims. Neither the marking of the patent number on any product nor the identification of the patent number in connection with any service should be deemed a representation that all embodiments described herein are incorporated into such product or service.

Polyurethane dispersions are resins dispersed in water which can produce a unique combination of toughness, mechanical properties and durability typically not achievable in other polymer chemistries. These resins are used on a wide range of surfaces and applications, including wood, metal, plastics, masonry and textiles. Meanwhile, water-based polyurethanes dispersion for manufacture of adhesive has excellent performance on heat resistant, fast drying, endurance bonding strength and atomization. However, there are three types of bonds that are most susceptible to hydrolysis in polyurethane systems. They are the urethane and urea linkages formed from the isocyanate/hydroxyl and isocyanate/amine reactions, respectively, and the ester groups that are in the backbone of a polyester-based polyurethane. The general order of resistance (with all other things being equal) to hydrolysis by these functional groups is ester<<urea<urethane.

Another disadvantage of using polyurethane dispersions as a binder in coatings is poor adhesive strength with metal substrate. Normally, an etch primer should be applied on the surface of the metal substrate first, then the polyurethane dispersion based coating can be tightly bonded on the surface of the etch primer. A pore structure inside the polyurethane coating can be generated due to by-products of CO₂ during the reaction of isocyanate and water. Therefore, a polyurethane network needs additional modification to achieve improved anti-hydrolysis and anticorrosion properties.

Accordingly, there is a need for hybrid waterborne primers based on polyurethanes that have been modified in order to increase the anti-hydrolysis and anticorrosion properties, while providing the advantages of the polyurethane waterborne primer.

In certain embodiments of the hybrid primer of the present invention, the hybrid primer comprises a crosslinked polymer network formed from a polyurethane dispersion, an organosilicon based compound containing one or more isocyanate functional groups, and, optionally, an additional isocyanate containing compound.

The polyurethane dispersion of these embodiments of hybrid primer is a waterborne dispersion (or aqueous dispersion) of a polyurethane, preferably formed from one of an aliphatic diisocyanate or aromatic diisocyanate, one or more diols or polyols, a catalyst, and optionally, one or more additives selected from the group consisting of chain extenders and crosslinkers conventional in polyurethane chemistry.

In certain embodiments, the polyurethane dispersion comprises one or more hydroxyl and/or carboxyl functional groups reactive with one or both of the additional isocyanate containing compound and the organosilicon based compound containing one or more isocyanate functional groups. The one or more of an aliphatic or aromatic diisocyanate can include, but is not limited to, hexamethylene diisocyanate (HDI), isophorone diisocyanate (IPDI), 4,4′-diisocyanato dicyclohexylmethane (HMDI), and tetramethylxylylene diisocyanate (TMXDI).

The additional isocyanate containing compound used in these embodiments can be any isocyanate compound reactive with either, and preferably with both of the organosilicon based compound containing one or more isocyanate functional groups, and the polyurethane dispersion, and can be preferably an aliphatic isocyanate containing compound or an aromatic isocyanate containing compound, which may optionally be modified with hydrophilic functional groups. In certain embodiments, the additional isocyanate containing compound is a water dispersible aromatic or aliphatic polyisocyanate. In further embodiments, the additional isocyanate containing compound can be one or more members selected from the group consisting of hexamethylene diisocyanate (HDI), isophorone diisocyanate (IPDI), 4,4′-diisocyanato dicyclohexylmethane (HMDI), and tetramethylxylylene diisocyanate (TMXDI).

In certain embodiments, the organosilicon based compound containing one or more isocyanate functional groups is selected from the group consisting of polysiloxanes containing one or more isocyanate functional groups and organosilanes containing one or more isocyanate functional groups.

In some embodiments of the present invention hybrid primer, the organosilicon based compound containing one or more isocyanate functional groups is an organosiloxane of formula (RO)₄₋ₙ Si—(R′—NCO)ₙ, where n=an integer of 1 to 4; R is an alkyl or aryl group, which may be substituted or unsubstituted, and R′ is an alkylene or arylene group, which may be substituted or unsubstituted. In certain embodiments, n=1 to 3. In other embodiments, R is an alkyl group and R′ is an alkylene group. In still further embodiments, R is a C₁-C₆ alkyl group and R′ is a C₁-C₆ alkylene group.

The hybrid polyurethane-silane waterborne primer of some embodiments of the invention can be prepared by any desired method by which the polyurethane is modified by reaction with the organosilicon compound having one or more isocyanate groups, in the presence of an additional isocyanate containing compound, including, but not limited to: (a) reacting the polyurethane dispersion and the organosilicon based compound containing one or more isocyanate functional groups in an aqueous medium, optionally in the presence of the additional isocyanate containing compound, to form a silane functionalized polyurethane dispersion, and crosslinking the silane functionalized polyurethane dispersion, or (b) bonding the organosilicon based compound containing one or more isocyanate functional groups to hydroxyl or amino groups contained on a surface of a structure on which the hybrid primer will be placed, wherein, optionally prior to bonding of the organosilicon based compound containing one or more isocyanate functional groups, the surface of the structure is optionally modified with an etching primer in order to form the hydroxyl or amino groups on the surface of the structure, reacting the polyurethane dispersion with the thus bound organosilicon based compound containing one or more isocyanate functional groups, and hydrolyzing the resulting composition to crosslink the polyurethane and bound organosilicon based compound containing one or more isocyanate functional groups.

In either of the above methods (a) or (b), an embodiment of the method of the invention includes, prior to reacting with the polyurethane dispersion, hydrolyzing and condensing the organosilicon based compound containing one or more isocyanate functional groups to form a crosslinked polysiloxane network which is then connected to the polyurethane network through bonding between the two. In further embodiments of the method of (a) or (b), the additional isocyanate containing compound is present and the reacting includes reacting the polyurethane dispersion, the organosilicon based compound containing one or more isocyanate functional groups, and the additional isocyanate containing compound with one another.

In certain embodiments of the present invention hybrid polyurethane-silane waterborne primer, the primer is applied to a substrate, such as a cold rolled steel substrate, with or without an etch primer being used. In embodiments where the etch primer is used, one can use conventional etch primers (such as epoxy etch primers), or can use a hybrid epoxy-polysiloxane waterborne primer as the etch primer, which is described in more detail below.

In certain embodiments of the invention, the etch primer is a hybrid epoxy-polysiloxane having excellent anticorrosion and anti-degradation properties. Typically, epoxy resins demonstrate good chemical and thermal stability, adhesive and mechanical strength, which can be used for anti-corrosion properties. However, epoxy resins often exhibit a high rigidity property, which can reduce the flexibility of a coating formed therefrom, and sanding capability is also a challenge, due to slow reaction between epoxide rings and amine groups at room temperature. Poor adhesive strength between basecoat and conventional waterborne epoxy primer is often found as well.

Polysiloxane is a rubber type polymer having more hydrophobic and flexible properties compared with epoxy resins. In certain embodiments of the present invention, epoxy resin and polysiloxane are combined to form a hybrid etch primer in order to provide the anticorrosion benefits of the epoxy and the flexibility and hydrophobic properties of the polysiloxane in a single hybrid primer composition. The present invention utilizes the hydrophobic property of polysiloxane to provide the capability to prevent penetration of water moisture through the film and the flexibility of polysiloxane chains to offer a softer more flexible property to the final film coated on a substrate, which improves overall flexibility of the film. Further, by using a silicon based compound containing one or more amino or hydroxyl functional groups in providing the polysiloxane based portion of the hybrid etch primer, the hybrid etch primer of these embodiments of the invention enhance the adhesive strength between coating layers. Organosilane with hydroxyl and amine groups in waterborne etch primer can also provide reaction sites for silane with isocyanate group and isocyanate, by which the adhesive strength of hybrid polyurethane-saline waterborne primer with etch primer is significantly improved.

Accordingly, in certain embodiments of the invention, the waterborne hybrid etch primer comprises a crosslinked network formed from an epoxy resin and one or more of a polysiloxane and/or a silicon based compound containing one or more amino or hydroxyl functional groups.

The epoxy resin of such an etch primer includes, but is not limited to, epoxies formed from epichlorohydrin and one or more bisphenol compounds. The one or more bisphenol compounds can be any suitable bisphenol compound, and can be selected based on the end properties desired from the epoxy resin portion of the hybrid etch primer.

In certain embodiments, the bisphenol compound includes but is not limited to one or more compounds selected from the following:

| Structural formula | Name | CAS |
|---|---|---|
| 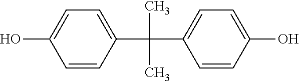 [SMILES: CC(C)(c1ccc(O)cc1)c1ccc(O)cc1] | Bisphenol A | 80-05-7 |
| 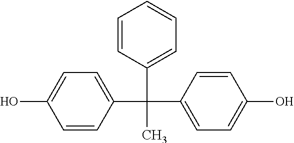 [SMILES: CC(c1ccccc1)(c1ccc(O)cc1)c1ccc(O)cc1] | Bisphenol AP | 1571-75-1 |
| 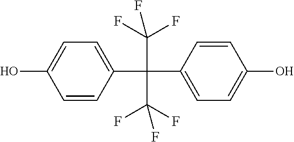 [SMILES: Oc1ccc(C(c2ccc(O)cc2)(C(F)(F)F)C(F)(F)F)cc1] | Bisphenol AF | 1478-61-1 |
| 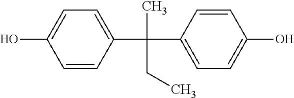 [SMILES: CCC(C)(c1ccc(O)cc1)c1ccc(O)cc1] | Bisphenol B | 77-40-7 |
| 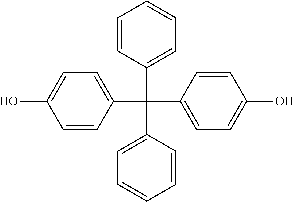 [SMILES: Oc1ccc(C(c2ccccc2)(c2ccccc2)c2ccc(O)cc2)cc1] | Bisphenol BP | 1844-01-5 |
| 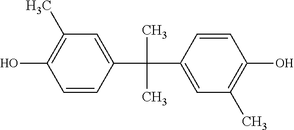 [SMILES: Cc1cc(C(C)(C)c2ccc(O)c(C)c2)ccc1O] | Bisphenol C | 79-97-0 |
| 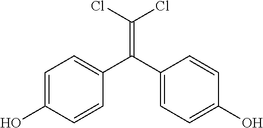 [SMILES: Oc1ccc(C(=C(Cl)Cl)c2ccc(O)cc2)cc1] | Bisphenol C 2 | 14868-03-2 |
| 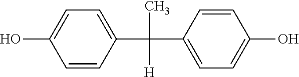 [SMILES: CC(c1ccc(O)cc1)c1ccc(O)cc1] | Bisphenol E | 2081-08-5 |
| 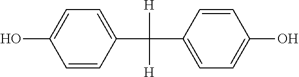 [SMILES: Oc1ccc(Cc2ccc(O)cc2)cc1] | Bisphenol F | 620-92-8 |
| 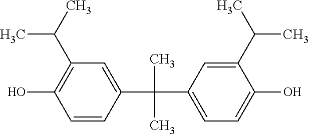 [SMILES: CC(C)c1cc(C(C)(C)c2ccc(O)c(C(C)C)c2)ccc1O] | Bisphenol G | 127-54-8 |
| 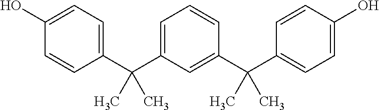 [SMILES: CC(C)(c1ccc(O)cc1)c1cccc(C(C)(C)c2ccc(O)cc2)c1] | Bisphenol M | 13595-25-0 |
| 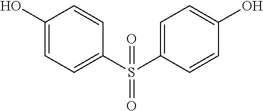 [SMILES: O=S(=O)(c1ccc(O)cc1)c1ccc(O)cc1] | Bisphenol S | 80-09-1 |
| 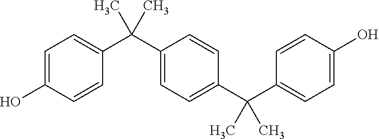 [SMILES: CC(C)(c1ccc(O)cc1)c1ccc(C(C)(C)c2ccc(O)cc2)cc1] | Bisphenol P | 2167-51-3 |
| 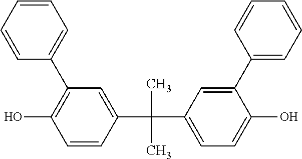 [SMILES: CC(C)(c1ccc(O)c(-c2ccccc2)c1)c1ccc(O)c(-c2ccccc2)c1] | Bisphenol PH | 24038-68-4 |
| 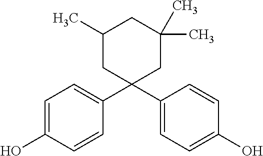 [SMILES: CC1CC(C)(C)CC(c2ccc(O)cc2)(c2ccc(O)cc2)C1] | Bisphenol TMC | 129188-99-4 |
| 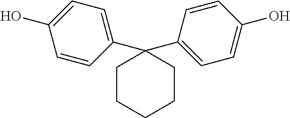 [SMILES: Oc1ccc(C2(c3ccc(O)cc3)CCCCC2)cc1] | Bisphenol Z | 843-55-0 |
| 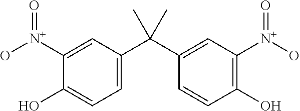 | Dinitrobisphenol A | 5329-21-5 |
| 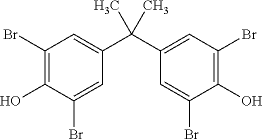 [SMILES: CC(C)(c1cc(Br)c(O)c(Br)c1)c1cc(Br)c(O)c(Br)c1] | Tetrabromobisphenol A | 79-94-7 |

Preferably, the one or more bisphenol compounds are selected from the group consisting of bisphenol A, bisphenol B, bisphenol E, bisphenol F, and bisphenol AF.

Curing (or crosslinking) of the epoxy resin may be achieved by reacting an epoxy with itself (homopolymerisation) or by forming a copolymer with polyfunctional curatives or hardeners. This curing is what produces the qualities of the substance such as resistance, durability, versatility, and adhesion. Any desired molecule containing a reactive hydrogen may be used to react with the epoxide groups of the epoxy resin. Common classes of hardeners for epoxy resins include amines, acids, acid anhydrides, phenols, alcohols and thiols. These have a relative reactivity (lowest first) approximately in the order: phenol<anhydride<aromatic amine<cycloaliphatic amine<aliphatic amine<thiol.

While some epoxy resin/hardener combinations will cure at ambient temperature, some may require heat. Temperature is sometimes increased in a step-wise fashion to control the rate of curing and prevent excessive heat build-up from the exothermic reaction.

Hardeners which show only low or limited reactivity at ambient temperature, but which react with epoxy resins at elevated temperature are referred to as latent hardeners. When using latent hardeners, the epoxy resin and hardener may be mixed and stored for some time prior to use, which is advantageous for many industrial processes.

The epoxy curing reaction may also be accelerated by addition of small quantities of accelerators. Tertiary amines, carboxylic acids and alcohols (especially phenols) are effective accelerators.

The epoxy resin can be prepared using conventional methods. For example, one method for preparing the epoxy resin used in the present invention is as follows: First, deionized water as solvent, a disperser, a defoamer, a water compatible co-solvent, and an anti-rust agent are combined in a first vessel. Then, pigments, fillers, and anti-corrosion agents are combined in a second vessel, into which the contents of the first vessel are then added and mixed at high speed to disperse the particles contained therein. After cooling to room temperature, the epoxy latex, a levelling agent, and additional defoamer are added and mixed at room temperature.

In some embodiments of the epoxy-polysiloxane waterborne hybrid etch primer, the silicon based compound containing one or more amino or hydroxyl functional groups is selected from the group consisting of polysiloxanes containing one or more amino or hydroxyl functional groups and organosilanes containing one or more amino or hydroxyl functional groups.

In some embodiments, the silicon based compound containing one or more amino or hydroxyl functional groups has a formula R¹O—[O—Si—(OH)(—R²—NH₂)]ₓ—OR³, where R¹ is independently H, an alkyl group, an aryl group, or a group of formula (R⁴O)₂Si—, each R² is independently an alkylene or arylene group, R³ is independently H, an alkyl group, an aryl group, or a group of formula —Si(—OR⁴)₂(—R²—NH₂), each R⁴ is independently H, an alkyl group or an aryl group, and x is an integer from 1 to 5000; preferably R′ is H and each R² is a C₁-C₆ alkylene group; more preferably each R² is a C₃ alkylene group.

The epoxy-polysiloxane waterborne hybrid etch primer of some embodiments of the invention can be prepared by any desired method by which the epoxy resin and organosilicon based compound containing one or more amino or hydroxyl functional groups react and become a crosslinked network, including, but not limited to: (a) reacting the epoxy resin and the polysiloxane and/or organosilicon based compound containing one or more amino or hydroxyl functional groups in an aqueous medium to form the crosslinked epoxy-polysiloxane hybrid etch primer, or (b) bonding the organosilicon based compound containing one or more amino or hydroxyl functional groups to hydroxyl or amino groups contained on a surface of a structure on which the hybrid etch primer will be placed, wherein, optionally prior to bonding of the organosilicon based compound containing one or more amino or hydroxyl functional groups, the surface of the structure is optionally modified with an etching primer in order to form the hydroxyl or amino groups on the surface of the structure, reacting the epoxy resin with the one or more amino functional groups of the thus bound organosilicon based compound containing one or more amino or hydroxyl functional groups, to form the crosslinked epoxy resin and polysiloxane hybrid etch primer.

In either of the above noted methods (a) and (b), an embodiment of the method of the invention includes, prior to reacting with the epoxy resin, hydrolyzing and condensing the organosilicon based compound containing one or more amino or hydroxyl functional groups to form a crosslinked polysiloxane network. The organosilane can be a small molecular weight silane, an oligomer, a polyhedral oligomer silsequioxane (POSS) or a ladder structure silane.

One embodiment of the present invention hybrid epoxy-polysiloxane waterborne etch primer can be formed by reacting an epoxy resin with a polysiloxane containing one or more amine and/or hydroxyl functional groups and an organosilane containing one or more amine and/or hydroxyl functional groups. In such a reaction, the equivalent weight ratio of epoxy to amine can be in a range of 1.1 to 2.5, preferably from about 1.4 to 1.9, more preferably about 1.7. An aliphatic amine curing agent (such as Anquamine 721) can be used, which reacts with epoxide rings on the epoxy resin to develop a crosslinked epoxy network. The polysiloxane network can be prepared by condensing a hydrolyzed polysiloxane and the organosilane to generate a crosslinked polysiloxane network. In addition, the amine group on the polysiloxane and organosilane also reacts with epoxide rings in the epoxy resin to crosslink the two networks with each other. The result is not a traditional interpenetrating polymer network (IPN). Rather, the crosslinking density in a film formed from the hybrid etch primer is dramatically increased by those reactions.

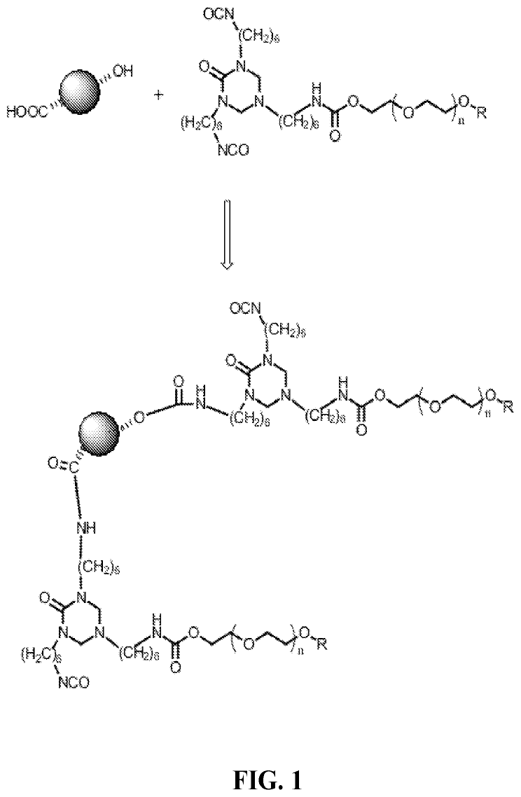

Turning back to the present invention hybrid polyurethane-silane containing waterborne primer, in certain embodiments, a waterborne polyurethane dispersion primer, preferably having surface attached hydroxyl groups is reacted with an additional isocyanate containing compound to generate a crosslinked polyurethane network, as shown in FIG. 1. The crosslinking density of the resulting polyurethane network can be adjusted by equilibrant weight ratio of NCO to OH groups present in the reactants.

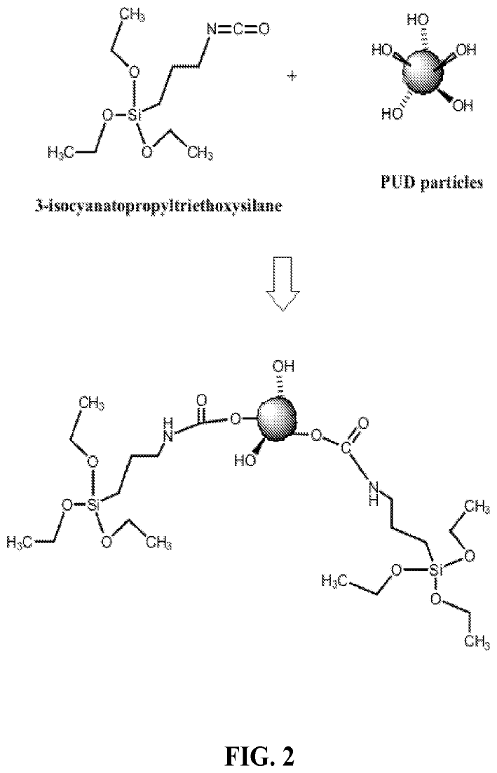

In other embodiments, an organosilicon compound containing one or more isocyanate groups (such as, for example, 3-isocyanatopropyltriethoxysilane as shown in FIG. 2) is added to a waterborne polyurethane primer along with the additional isocyanate containing compound. The one or more isocyanate functional groups on the organosilicon compound can react with polyurethane dispersion particles having hydroxyl groups to develop a crosslinked network, which significantly increases the crosslinking density of the polyurethane network, and can enhance the chemical and/or thermal stability of polyurethane

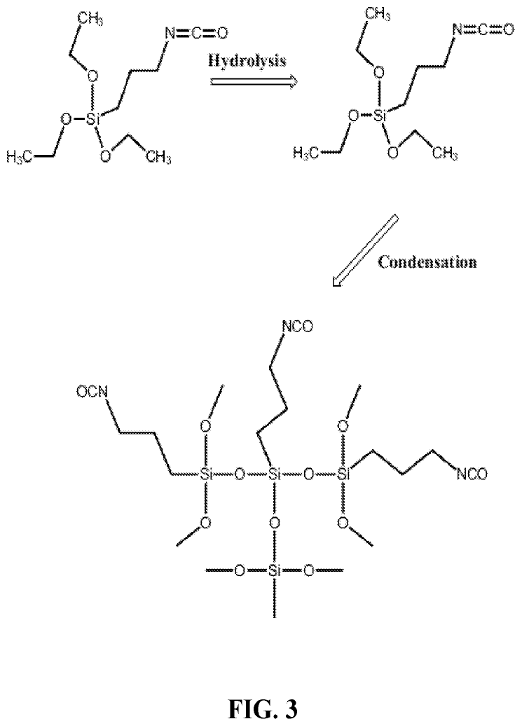

In alternative embodiments of the hybrid polyurethane-silane waterborne primers of the present invention, prior to reaction of the organosilicon compound having one or more isocyanate groups with the polyurethane dispersion, the organosilicon compound having one or more isocyanate groups (such as, for example, 3-isocyanatopropyltriethoxysilane) is hydrolyzed, then condensed to create a crosslinked polysiloxane network as shown in FIG. 3. The thus formed hydrophobic polysiloxane network can effectively inhibit the penetration of water moisture through the coating on the substrate. Due to the more flexible Si—O bond in the backbone of the polysiloxane, the flexibility of the coating will be substantially increased. To this crosslinked polysiloxane network, the polyurethane dispersion can be further reacted to form a hybrid primer layer of embodiments of the present invention.

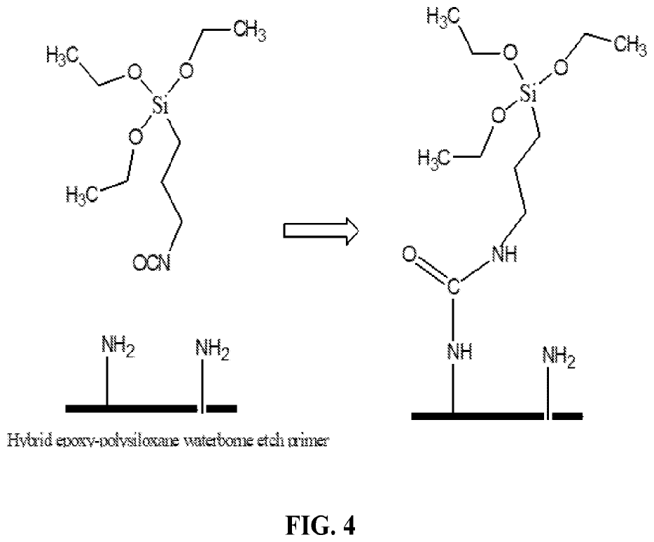

In further embodiments of the present invention, the organosilicon compound containing one or more isocyanate groups (such as, for example, 3-isocyanatopropyltriethoxysilane) can be bonded on the surface of a waterborne etch primer layer by reaction between isocyanate groups and hydroxyl groups as indicated in FIG. 4, by which, the organosilicon compound will be covalently bonded on the surface of the etch primer layer and hydroxyl groups on silane compound can further react with the additional isocyanate containing compound and polyurethane dispersion or condensed with itself to develop a crosslinked network.

Cold rolled steel substrates were coated using (1) a waterborne polyurethane dispersion without the organosilicon compound modification of the present invention, (2) a waterborne polyurethane-silicon hybrid primer of embodiments of the present invention, or (3) a conventional 2K polyurethane solvent borne primer using an initial solvent borne epoxy based etch primer.

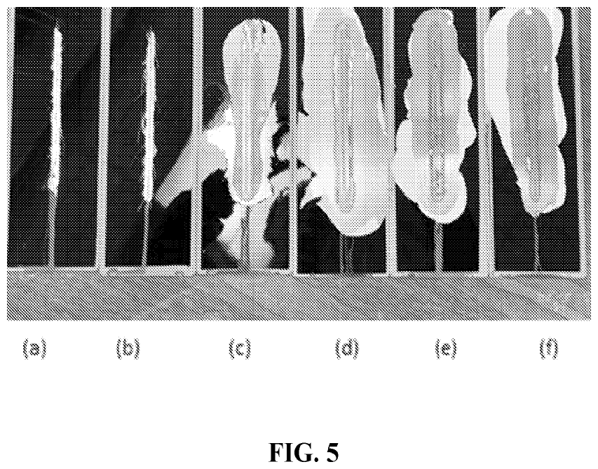

FIG. 5 shows the pictures of substrates coated with (3) the conventional 2K polyurethane solvent borne primer (samples (a) and (b)) and (1) the waterborne polyurethane dispersion without the organosilicon compound modification of the present invention (samples (c), (d), (e), and (f)). Much worse corrosion was observed with the substrates coated with (1) the waterborne polyurethane dispersion without the organosilicon compound modification of the present invention. Most of the coatings were delaminated from the substrates and more corrosion was found on the substrates with the conventional waterborne polyurethane dispersion without the organosilicon compound modification of the present invention compared with the substrates coated with the conventional 2K polyurethane solvent borne primer.

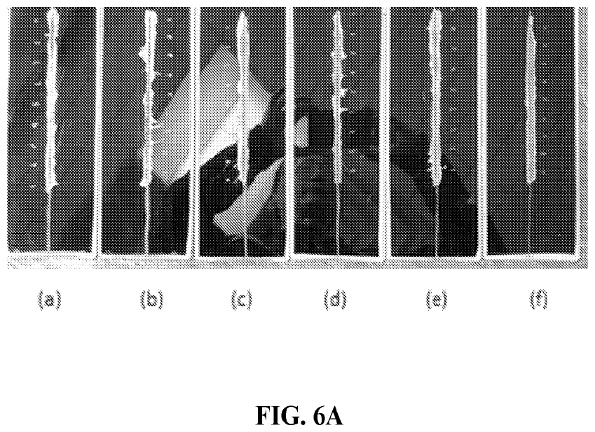

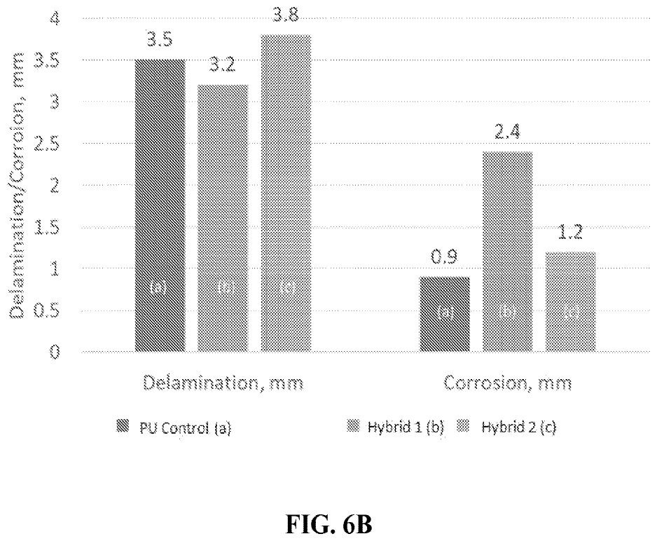

FIGS. 6A and 6B show the pictures (FIG. 6A) and graphical representation (FIG. 6B) of results of substrates after salt spray chamber testing of (3) the conventional 2K polyurethane solvent borne primer (samples (a) and (b)) compared to (2) a waterborne polyurethane-silicon hybrid primer of embodiments of the present invention (samples (c), (d) for hybrid primer 1, and samples (e), and (f) for hybrid primer 2). FIG. 6B shows graphically the delamination and corrosion results for a solvent borne polyurethane primer control (a), hybrid primer 1 of the present invention (b) and hybrid primer 2 of the present invention (c). The hybrid polyurethane waterborne primer modified by organosilicon compound provided nearly the same anticorrosion performance as the conventional polyurethane solvent borne primer control. Hybrid primer 2 of the present invention showed better anticorrosion performance than hybrid primer 1 of the present invention. This difference is believed to be because hybrid primer 2 has a higher level of the organosilane with isocyanate, giving a higher equivalent ratio of NCO to OH in hybrid primer 2 compared to hybrid primer 1 of the present invention.

The hybrid polyurethane waterborne primer modified by organosilicon compound of embodiments of the present invention provides comparable properties to the conventional polyurethane solvent borne primer control in most properties. Adhesive strength of the embodiments of the present invention could be varied by increasing the NCO to OH ratio as desired.

In tests of anti-hydrolysis performance by humidity chamber testing, the hybrid polyurethane waterborne primer modified by organosilicon compound of embodiments of the present invention provided comparable properties to the conventional polyurethane control, particularly at higher NCO to OH ratios. At lower NCO to OH ratios of about 0.7 or less the hybrid primer of the present invention gives poorer adhesion and anti-hydrolysis performance. Coatings using embodiments of the present invention hybrid polyurethane waterborne primer modified by organosilicon compound having NCO to OH ratios of greater than 0.7 show significant improvements in adhesive strength and antihydrolysis performance, including greater cohesion between layers, particularly when the additional isocyanate compound is used in production of the hybrid primer of the invention.

Humidity chamber testing of embodiments of the hybrid polyurethane waterborne primer modified by organosilicon compound of embodiments of the present invention showed significant improvements in anti-hydrolysis and adhesive performance compared to the control.

Durability testing of embodiments of the hybrid polyurethane waterborne primer modified by organosilicon compound of the present invention showed significant improvements using the invention hybrid primer compared to the conventional polyurethane solvent borne primer control.

By way of example of application of the hybrid polyurethane waterborne primer modified by organosilicon compound of the present invention, a cold rolled steel substrate is polished by treatment with sandpaper (180 #), followed by application of an embodiment of the above described hybrid epoxy-polysiloxane waterborne primer as a waterborne etch primer by spraying on the surface of the substrate. The resulting coating is dried with forced air, then the spraying and drying process repeated until the final thickness of the etch primer coating is about 1.7-2.0 mil. Afterward, the hybrid polyurethane waterborne primer modified by organosilicon compound of embodiments of the present invention is sprayed on the coating of waterborne etch primer and forced air dried for a time sufficient to develop a tack-free surface. The total coating thickness can be any desired thickness, and is preferably about 3.2-3.7 mil. After drying overnight at room temperature (23° C.) and normal humidity (~50%), the thus coated substrates are sanded with 400# and 600# sandpaper, respectively. In the end, a waterborne polyacrylate basecoat and a solvent borne clearcoat are sprayed on the coated substrate separately, and dried before evaluation.

In order to test performance of certain embodiments of the present invention coated on cold rolled steel panels, especially anti-corrosion performance, a hybrid polyurethane and silane with isocyanate group waterborne primer is used as waterborne primer (WBP) and a hybrid epoxy-polysiloxane is used as waterborne etch primer (WBEP).

Basic properties of panels coated with either a polyurethane primer control or a hybrid polyurethane-silane primer can be seen from Table 1.

TABLE 1

| ID | Control | Hybrid 1 | Hybrid 2 |
|---|---|---|---|
| Chemistry of primer | 2K solvent borne epoxy | Present invention hybrid | Present invention hybrid |
| and etch primer | as etch primer and 2K | epoxy/siloxane and silane- | epoxy/siloxane and silane-NH₂ |
| | solvent borne PU as | NH₂ etch primer; eq. ratio of | etch primer; eq. ratio of epoxy |
| | primer | epoxy to amine: 2.91; hybrid | to amine: 2.91; hybrid |
| | | polyurethane-silane | polyurethane-silane |
| | | waterborne primer; Eq. ratio | waterborne primer; Eq. ratio |
| | | NCO to OH: 0.35 | NCO to OH: 0.69 |

Primer on CRS substrate

| | | | |
|---|---|---|---|
| Cross-hatch | 5B | 5B | 5B |
| MEK rub (cycle) | >300 | >300 | >300 |

Full coating layers set panel

| Coating layer | etch primer/primer/basecoat/clearcoat (mil) | | |
|---|---|---|---|
| Thickness, mil | 0.9/3.1/1.0/3.3 | 1.7/3.2/0.9/2.8 | 2.0/3.7/1.0/3.4 |
| Impact | 160/160 | 160/160 | 160/160 |
| (direct/indirect), psi | | | |
| Conical mandrel | Pass | Pass | Pass |
| bend | | | |
| Dry adhesive (cross- | 8% of adhesion failure | 22% of cohesion | 8% of cohesion |
| hatch) | between basecoat and | failure on primer | failure on primer |
| | primer | | |
| Gloss (20 degree) | 89.7 | 89.3 | 89.5 |
| DOI | 90.9 | 87.1 | 90.2 |
| Dry time (tack-free), | Longer than 45 min, but shorter with force drying | | |
| min | | | |

| | |
|---|---|
| Pot life, min | >60 min |

It is clear most of the properties of the coatings of the present invention hybrid polyurethane-silane primer are comparable with control. Hybrid 1 in Table 1 shows worse adhesive strength, which is believed to be attributable to the lower equivalent weight (EW) ratio of NCO to OH (0.5). This lower EW ratio can result in lower crosslink density in the coating produced, which can reduce adhesive strength of the formed coating.

Comparison of the samples in gloss 20 and DOI properties both before and after a humidity chamber test at 1 h and 24 h shows no significant difference in optical apparency in the coatings.

Comparison of the adhesive strength loss of the coatings on panels (etch primer/primer/basecoat/clearcoat layering) after humidity chamber exposure for 1 h and 24 h shows that while there is a dramatic increase in adhesive strength loss after 24 hours for the present invention samples compared to control, the adhesive failure mode is different between the present invention primer compared to control. The present invention samples show cohesive failure in the basecoat layer, while the control formulation shows failure between basecoat and primer. Since the force required to cause cohesion failure within the basecoat layer is much higher than that for adhesive failure between basecoat and primer layers, the present invention shows much greater adhesion between the hybrid primer layer and the basecoat in the samples using the present invention embodiments.

The stability of coating compositions of embodiments of the present invention shows no significant change in viscosity after storage for 30 days at 40° C.

The above results were determined in accordance with the following tests:

Chemical resistance of primer—To check chemical resistance of a primer, panels coated with etch primer and primer are rubbed by one hammer covered with three layers of fiber paper soaked with MEK solvent. The specification of chemical resistance with MEK testing is more than 300 cycles without the surface being dissolved and steel surface being exposed, in accordance with ASTM D5402-19.

Adhesive strength—The adhesive strength of coating/film is evaluated by crosshatch testing in accordance with ASTM D3359. The failure mode of coating/film is also assessed based on observation of peeled coating/film on tape and substrate. This test rates the adhesion strength of the coating/film on each layer by removing pressure-sensitive tape stuck to the film cut by crosshatch.

Impact resistance—Impact resistance of coating/film coated on panels are assessed in accordance with ASTM D5420. The data is repeated twice, and both coated and non-coated sides are tested and recorded as direct and non-direct impact strength.

Conical Mandrel Bend—Flexible capability of coating/film is evaluated by Conical Mandrel Bend in accordance with ASTM D522.

Stone chip testing—Durability of film is measured in accordance with GM 14729.

Optical appearance—Optical apparency of coating/film is evaluated by Gloss Retention (20 Deg Gloss) and DOI Retention (Wavescan).

Humidity Chamber—Panels with edges are put into a humidity chamber at a temperature of about 30° C. for 4 days in accordance with GM 14729. The panels are dried with fiber paper after removal from the chamber and exposed at room temperature for 1 and 24 hours. The coating/film is then measured to determine Gloss (20 degree), DOI and cross-hatch.

Salt fog chamber—Panels with edges painted and having one line scratched in the middle are put in the salt fog chamber at a temperature of about 30° C. for 20 days in accordance with ASTM B117. The panels are washed with hot water and any loose coating/film removed with a metal spatula after removal from the chamber. The size of delamination and corrosion area are measured, and ten measured data points are averaged.

Stability test —Primer compositions are measured for viscosity and pH prior to placement in an oven at 40° C. The samples are then checked after 10, 20 and 30 days for viscosity and pH to confirm stability.

While the embodiments discussed herein have been related to the hybrid epoxy-polysiloxane waterborne primers and methods discussed above, these embodiments are intended to be examples only and are not intended to limit the applicability of these embodiments to only those discussions set forth herein.

The above description is merely illustrative of several possible embodiments of various aspects of the present invention, wherein equivalent alterations and/or modifications will occur to others skilled in the art upon reading and understanding this specification and the annexed drawings. In addition, although a particular feature of the invention may have been disclosed with respect to only one of several implementations, such feature may be combined with one or more other features of the other implementations as may be desired and advantageous for any given or particular application.

The following are non-limiting examples of some embodiments of the present invention:
Embodiment 1. A hybrid primer comprising a crosslinked polymer network formed from a polyurethane dispersion, an organosilicon based compound containing one or more isocyanate functional groups, and, optionally, an additional isocyanate containing compound.
Embodiment 2. The hybrid primer of Embodiment 1, wherein the polyurethane dispersion comprises hydroxyl and carboxyl functional groups reactive with one or both of the additional isocyanate containing compound, when present, and the organosilicon based compound containing one or more isocyanate functional groups.
Embodiment 3. The hybrid primer of one of Embodiments 1 or 2, wherein the organosilicon based compound containing one or more isocyanate functional groups is selected from the group consisting of polysiloxanes containing one or more isocyanate functional groups and organosilanes containing one or more isocyanate functional groups
Embodiment 4. The hybrid primer of any one of Embodiments 1 to 3, wherein the polyurethane dispersion comprises a polyurethane formed from one of an aliphatic diisocyanate or an aromatic diisocyanate, one or more diols or polyols, a catalyst, and, optionally, one or more additives selected from the group consisting of chain extenders and crosslinkers.
Embodiment 5. The hybrid primer of any one of Embodiments 1 to 4, wherein the additional isocyanate containing compound is present and is an aliphatic isocyanate containing compound or an aromatic isocyanate containing compound, which may optionally be modified with hydrophilic functional groups, and either of which may be blocked or unblocked.
Embodiment 6. The hybrid primer of any one of Embodiments 1 to 5, wherein the additional isocyanate containing compound is present and is a water dispersible aromatic or aliphatic polyisocyanate.
Embodiment 7. The hybrid primer of any one of Embodiments 1 to 5, wherein the additional isocyanate containing compound is present and is a member selected from the group consisting of hexamethylene diisocyanate (HDI), isophorone diisocyanate (IPDI), 4,4′-diisocyanato dicyclohexylmethane (HMDI), tetramethylxylylene diisocyanate (TMXDI), and blocked derivatives thereof.
Embodiment 8. The hybrid primer of any one of Embodiments 1 to 7, wherein the organosilicon based compound containing one or more isocyanate functional groups is an organosiloxane of formula (RO)₄₋ₙSi—(R′—NCO)ₙ, where n=an integer of 1 to 4; R is an alkyl or aryl group, which may be substituted or unsubstituted, and R′ is an alkylene or arylene group, which may be substituted or unsubstituted.
Embodiment 9. The hybrid primer of Embodiment 8, where n=1 to 3.
Embodiment 10. The hybrid primer of one of Embodiments 8 or 9, where R is an alkyl group and R′ is an alkylene group.
Embodiment 11. The hybrid primer of any one of Embodiments 8 to 10, where R is a C₁-C₆ alkyl group and R′ is a C₁-C₆ alkylene group.
Embodiment 12. A waterborne hybrid primer composition comprising the hybrid primer of any one of Embodiments 1 to 11 in an aqueous medium.
Embodiment 13. A method of preparing the hybrid primer of any one of Embodiments 1 to 12, comprising:
reacting the polyurethane dispersion and the organosilicon based compound containing one or more isocyanate functional groups in an aqueous medium, optionally in the presence of a catalyst, to form a silane functionalized polyurethane dispersion, and
crosslinking the silane functionalized polyurethane dispersion.
Embodiment 14. The method of Embodiment 13, wherein the organosilicon based compound containing one or more isocyanate functional groups is hydrolyzed and condensed to form a crosslinked polysiloxane network.
Embodiment 15. The method of one of Embodiments 13 or 14, further comprising the additional isocyanate containing compound, and wherein the reacting includes reacting the polyurethane dispersion, the organosilicon based compound containing one or more isocyanate functional groups, and the additional isocyanate containing compound with one another.
Embodiment 16. A method of preparing the hybrid primer of any one of Embodiments 1 to 12, comprising:
bonding the organosilicon based compound containing one or more isocyanate functional groups to hydroxyl or amino groups contained on a surface of a structure on which the hybrid primer will be placed, wherein, optionally prior to bonding of the organosilicon based compound containing one or more isocyanate functional groups, the surface of the structure is optionally modified with an etching primer in order to form the hydroxyl or amino groups on the surface of the structure,
reacting the polyurethane dispersion with the thus bound organosilicon based compound containing one or more isocyanate functional groups, and
hydrolyzing the resulting composition to crosslink the polyurethane and bound organosilicon based compound containing one or more isocyanate functional groups.

Additional modifications and variations of the present invention are possible in light of the above teachings. It is therefore to be understood that within the scope of the appended claims, the invention may be practiced otherwise than as specifically described herein.

What is claimed is:

1. A hybrid primer comprising a crosslinked polymer network formed from a polyurethane dispersion, an organosilicon based compound containing one or more isocyanate functional groups, and, optionally, an additional isocyanate containing compound.

2. The hybrid primer of claim 1, wherein the polyurethane dispersion comprises hydroxyl and carboxyl functional groups reactive with one or both of the additional isocyanate containing compound, when present, and the organosilicon based compound containing one or more isocyanate functional groups.

3. The hybrid primer of claim 1, wherein the organosilicon based compound containing one or more isocyanate functional groups is selected from the group consisting of polysiloxanes containing one or more isocyanate functional groups and organosilanes containing one or more isocyanate functional groups

4. The hybrid primer of claim 1, wherein the polyurethane dispersion comprises a polyurethane formed from one of an aliphatic diisocyanate or an aromatic diisocyanate, one or more diols or polyols, a catalyst, and, optionally, one or more additives selected from the group consisting of chain extenders and crosslinkers.

5. The hybrid primer of claim 1, wherein the additional isocyanate containing compound is present and is an aliphatic isocyanate containing compound or an aromatic isocyanate containing compound, which may optionally be modified with hydrophilic functional groups, and either of which may be blocked or unblocked.

6. The hybrid primer of claim 1, wherein the additional isocyanate containing compound is present and is a water dispersible aromatic or aliphatic polyisocyanate.

7. The hybrid primer of claim 1, wherein the additional isocyanate containing compound is present and is a member selected from the group consisting of hexamethylene diisocyanate (HDI), isophorone diisocyanate (IPDI), 4,4′-diisocyanato dicyclohexylmethane (HMDI), tetramethylxylylene diisocyanate (TMXDI), and blocked derivatives thereof.

8. The hybrid primer of claim 1, wherein the organosilicon based compound containing one or more isocyanate functional groups is an organosiloxane of formula (RO)₄₋ₙSi—(R′—NCO)ₙ, where n=an integer of 1 to 4; R is an alkyl or aryl group, which may be substituted or unsubstituted, and R′ is an alkylene or arylene group, which may be substituted or unsubstituted.

9. The hybrid primer of claim 8, where n=1 to 3.

10. The hybrid primer of claim 8, where R is an alkyl group and R′ is an alkylene group.

11. The hybrid primer of claim 8, where R is a C₁-C₆ alkyl group and R′ is a C₁-C₆ alkylene group.

12. A waterborne hybrid primer composition comprising the hybrid primer of claim 1 in an aqueous medium.

13. A method of preparing the hybrid primer of claim 1, comprising:
reacting the polyurethane dispersion and the organosilicon based compound containing one or more isocyanate functional groups in an aqueous medium, optionally in the presence of an additional isocyanate containing compound, to form a silane functionalized polyurethane dispersion, and
crosslinking the silane functionalized polyurethane dispersion.

14. The method of claim 13, wherein the organosilicon based compound containing one or more isocyanate functional groups is hydrolyzed and condensed to form a crosslinked polysiloxane network.

15. The method of claim 13, further comprising the additional isocyanate containing compound, and wherein the reacting includes reacting the polyurethane dispersion, the organosilicon based compound containing one or more isocyanate functional groups, and the additional isocyanate containing compound with one another.

16. A method of preparing the hybrid primer of claim 1, comprising:
bonding the organosilicon based compound containing one or more isocyanate functional groups to hydroxyl or amino groups contained on a surface of a structure on which the hybrid primer will be placed, wherein, optionally prior to bonding of the organosilicon based compound containing one or more isocyanate functional groups, the surface of the structure is optionally modified with an etching primer in order to form the hydroxyl or amino groups on the surface of the structure,
reacting the polyurethane dispersion with the thus bound organosilicon based compound containing one or more isocyanate functional groups, and
hydrolyzing the resulting composition to crosslink the polyurethane and bound organosilicon based compound containing one or more isocyanate functional groups.
